(19) United States
(12) Patent Application Publication
(10) Pub. No.: US 2016/0335850 A1
(43) Pub. Date: Nov. 17, 2016

(54) SYSTEM AND METHOD FOR PROVIDING AN ELECTRONIC GAME

(71) Applicant: Pineapple Games LTD., Vancouver (CA)

(72) Inventors: Eric Diep, Vancouver (CA); Brendan Forsyth, Vancouver (CA); Joseph William Lee, Atherton, CA (US)

(73) Assignee: Pineapple Games LTD.

(21) Appl. No.: 14/712,896

(22) Filed: May 14, 2015

(51) Int. Cl. G07F 17/32; A63F 13/30

(52) U.S. Cl. CPC G07F 17/3293; G07F 17/3225; A63F 13/30

(57) ABSTRACT

A system and method for providing an electronic game. In some implementations, the game may include a card game and/or other type of game played with cards, tokens, and/or other gameplay objects. The players may play the game according to rules to achieve the goal of the game. By way of non-limiting example, the goal of the game may be to obtain the best (e.g., highest ranked) game spread which may include obtaining the strongest groupings of cards using the same set of cards the other player(s). In some implementations, rules of the game may provide that the same set of cards be distributed to each of the players playing the game. Thus, the outcome of the game may be based on skill and judgement instead of luck.

### FIELD OF THE DISCLOSURE

The disclosure relates to systems and methods for providing an electronic game.

### BACKGROUND

Traditionally, card games utilize a deck of cards (e.g., a standard deck of 52 cards) that are distributed among players such that individual players have different cards. The players may play the game with their set of cards according to the game rules. Typically, the deck of cards may be shuffled and/or the cards distributed in a manner to ensure the players receive an unpredictable variety of cards. In fact, in most games, organizing or stacking the deck may be against the rules and considered cheating. As such, the outcome of most card games may be partially dependent on a player's luck, in addition to their skill and judgement. For example, casino style card games and/or card games played for money may require a certain degree of luck to beat the odds stacked against the player.

Electronic card games may be played in an electronic format through a web application, mobile application, or electronic gaming cabinet (such as a video gaming machine). Electronic card games typically use a shuffling algorithm to provide a random (or pseudorandom) distribution of cards to the players playing the game. As such, the shuffling algorithm may imitate physical shuffling of cards in the real world.

### SUMMARY

One aspect of the disclosure is related to a system and method for providing an electronic game. In some implementations, the game may include a card game and/or other type of game played with gameplay objects or tokens. The players may play the game according to rules to achieve the goal of the game. By way of non-limiting example, the goal of the game may be to obtain the best (e.g., highest ranked) game spread which may include obtaining the strongest groupings of cards using the same set of cards as their opponent(s). In some implementations, rules of the game may provide that the same set of cards be distributed to each of the players playing the game. Thus, the outcome of the game may be based on skill and judgement instead of luck. By way of non-limiting example, the game may require at least 17 cards per player per round. In some implementations, playing multiple rounds may require a large number of cards for each player. As such, it may not be feasible to play the game without a specialized computer system configured to determine the sets of the cards such that the same cards are distributed to each player in each round.

A system configured to provide an electronic game may include a server. The server may be configured to communicate with one or more client devices according to a client/server architecture. The client computing platforms may be associated with the users of the game. The server may be configured to execute one or more machine-readable instructions. The machine-readable instructions may include one or more of an account component, a gameplay object component, a gameplay management component, a scoring component, a wagering component, and/or other components.

In some implementations, the system may determine a set of cards to be played for a particular round of a game. The system may determine one or more identical sets of cards and/or other gameplay objects to be presented on client devices associated with players competing in the game. The sets of cards and/or other gameplay objects presented to all of the players competing against each other in the game may be the same. As such, luck may not be an outcome determinative factor of the game. The cards may be distributed to the players in one or more identical subsets. In some implementations, a first subset and one or more additional subsets may be distributed to the players. Card and/or gameplay object information indicating the subsets of the sets of cards and/or other gameplay objects may be transmitted to the client devices associated with the players. The card and/or gameplay object information may be transmitted to the client device(s) over a network. As such, the subsets of the sets of cards and/or other gameplay objects may be presented on the client devices. The subsets may include a predetermined number of cards and/or other gameplay objects from the set that are provided to a player at a given time. By way of non-limiting example, a first subset may include five cards.

The system may receive game commands from each player in the game specifying how the player chooses to play one or more cards and/or other gameplay objects in the game. In some implementations, the game commands may be received over the network from the client devices. The game commands may indicate placement of the cards and/or other gameplay objects included in the subsets of the sets of cards and/or other gameplay objects into game spreads. The game spreads may include locations having slots in which players may place cards and/or other gameplay objects during gameplay. An individual game spread may be associated with an individual player such that the gameplay of the individual player is displayed via their game spread. The game commands may indicate where in the game spreads to place the cards. The game spread may have a predetermined number of locations. Individual locations may have predetermined numbers of slots for card and/or other gameplay objects to be placed. The predetermined number of locations and/or the predetermined number of slots may include any number of locations and/or slots. By way of non-limiting example, the locations may include three rows where a back row has five slots (e.g., to hold five cards), a middle row has five slots, and a front row has three slots. The system may execute the game commands received by placing the cards and/or other gameplay objects into the game spreads. The cards and/or other gameplay objects may be placed into the game spreads in indicated slots within indicated locations (e.g., indicated by the game commands). In some implementations, after a player indicates the slots in which to place the cards and/or other gameplay objects in a given subset, the player may set the cards and/or other gameplay objects within the game spread such that their location and/or placement may not be moved, changed, and/or removed. By way of non-limiting example, the game rules may require a player to set the cards after cards from each subset have been placed.

In some implementations, the system may be configured to effectuate presentation of one or more game spreads including the cards and/or other gameplay objects placed within the game spread. The game spreads may be presented on a client device associated with the opposing player responsive to executing the game commands. By way of non-limiting example, the game spread of a given player may be presented to the opposing player after cards from each subset of cards are placed and/or set by the given player via the game commands. Continuing the non-limiting example, during each turn, a player may indicate placement (e.g., in slots at locations their game spread) of a predetermined number of cards presented in a subset of the set of cards and/or indicate discard of a predetermined number of cards presented in the subset of the set of cards.

The system may be configured to determine scores for individual ones of the players. Scores may be based on an accumulation of points. In some implementations, for example, the scores may be determined after all of the subsets of the sets of cards and/or gameplay objects have been presented to the players and the game spreads are complete. A complete game spread may include a full game spread having cards and/or gameplay objects placed at the predetermined number of slots within the predetermined number of locations. By way of non-limiting example, a complete game spread may include five cards placed at a first location (e.g., back row), five cards placed at a second location (e.g., middle row), and three cards placed at a third location (e.g., front row). Scores may be determined based on rankings of the game spreads. The rankings of the game may include rankings of the groupings of cards and/or other gameplay objects located at individual locations within the game spread. By way of non-limiting example, a grouping may include the cards placed in an individual row.

In some implementations, the game rules may indicate one or more requirements for game play. For example, requirement of the game may be to obtain a valid game spread set-up. Without a valid game spread set-up, a player may not qualify to receive a score for that round of the game. The valid game spread set-up may require the groupings to have a predetermined ranking order. By way of non-limiting example, a grouping of cards in the back row may be required to have a higher ranking than a grouping of cards in the middle row, and a grouping of cards in the middle row may be required to have a higher ranking than a grouping of cards in the front row. A higher ranking may include a stronger grouping of cards and/or other gameplay objects wherein the strengths and/or rankings are determined according to one or more game rules. By way of non-limiting example, the strengths and/or rankings may be determined according to standard card rankings and/or card grouping rankings. In some implementations, an invalid game spread set-up may cause the game spread to be forfeited and the player to lose to any opponent having a valid game spread set-up. As such, the player with an invalid game spread may lose and/or be penalized at least a predetermined number of points.

In some implementations, the scores may be determined at least partially based on relative rankings. Relative rankings may be based on a comparison between the groupings at corresponding locations in the players game spreads. In some implementations, bonus points may be provided to the player associated with a game spread including higher relative rankings for a predetermined number of groupings at the predetermined number of locations. For example, a player associated with a game spread having higher relative rankings for three groupings at three locations, wherein the game spread has slots for three groupings at three locations, may be provided with a bonus score.

In some implementations, the game scoring may be based on one or more of a valid game spread set-up, relative rankings comparing corresponding locations (e.g., rows) between game spreads of different players, actual rankings and/or strength of a grouping at a given location, and/or other factors. Responsive to the score being determined by the system, scoring information indicating the score may be transmitted to the client devices for presentation to the players. For example, in some implementations, after the players have completed their game spreads by placing (e.g., via game commands) and/or setting cards in the predetermined number of locations with the predetermined numbers of slots, a score may be determined by comparing rankings of the groupings at corresponding locations in the players game spreads and score information indicting the score may be transmitted for presentation on the client devices. By way of non-limiting example, the predetermined number of locations may include three (e.g., three rows) and/or the predetermined numbers of slots may include five or three (e.g., five or three card slots per row).

In some implementations, five subsets of the sets of cards may be distributed to each player and/or indicated by the card information for each round of the game played. By way of non-limiting example, the card information may indicate subsets of the sets of cards such that five cards may be presented in the first subset, three cards may be presented in a second subset, three cards may be presented in a third subset, three cards may be presented in a fourth subset, and/or three cards may be presented in a fifth subset. In some implementations, different subsets may be associated with different gameplay rules. For example, the player may have to play all five cards in the first subset. Continuing the example, the player may only be able to play two cards in the second, third, fourth, and fifth subsets, leaving one card that may be discarded for individual ones of the second, third, fourth, and fifth subsets. In some implementations, the sets of cards and the subsets of the sets of cards may be the same for the players competing in the game. As such, by way of non-limiting example, the same cards may be distributed to the players in the same order, but, because players may place cards within the game spread differently and discard differently, the game spreads and/or groupings (e.g., hands) within the game spread may be different.

In some implementations, the system may be configured to facilitate wagering in the game. The system may receive wager information over the network from the client devices. The wager information may indicate an amount of consideration the player(s) want to wager on the game and/or a subdivision of the game. The system may be configured to move consideration between player accounts based on the wager information, the scores of individual ones of the players determined for the game and/or the subdivision of the game, and/or other information.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for providing an electronic game, in accordance with an embodiment.

FIG. 2 illustrates a game spread, in accordance with an embodiment.

FIG. 3 illustrates a standard card ranking table, in accordance with an embodiment.

FIG. 4 illustrates a card grouping ranking table, in accordance with an embodiment.

FIG. 5 illustrates a graphical user interface through which the game is presented on a client device, in accordance with an embodiment.

FIG. 6 illustrates a graphical user interface through which the game is presented on a client device, in accordance with an embodiment.

FIG. 7 illustrates a graphical user interface through which the game is presented on a client device, in accordance with an embodiment.

FIG. 8 illustrates a graphical user interface through which the game is presented on a client device, in accordance with an embodiment.

FIG. 9 illustrates a graphical user interface through which the game is presented on a client device, in accordance with an embodiment.

FIG. 10 illustrates a graphical user interface through which the game is presented on a client device, in accordance with an embodiment.

FIG. 11 illustrates a method for providing an electronic game, in accordance with an embodiment.

### DETAILED DESCRIPTION

Various embodiments are described herein in detail with reference to the drawings. Reference to various embodiments does not limit the scope of the claims attached hereto. Additionally, any examples set forth in this specification are not intended to be limiting and merely set forth some of the many possible embodiments for the appended claims.

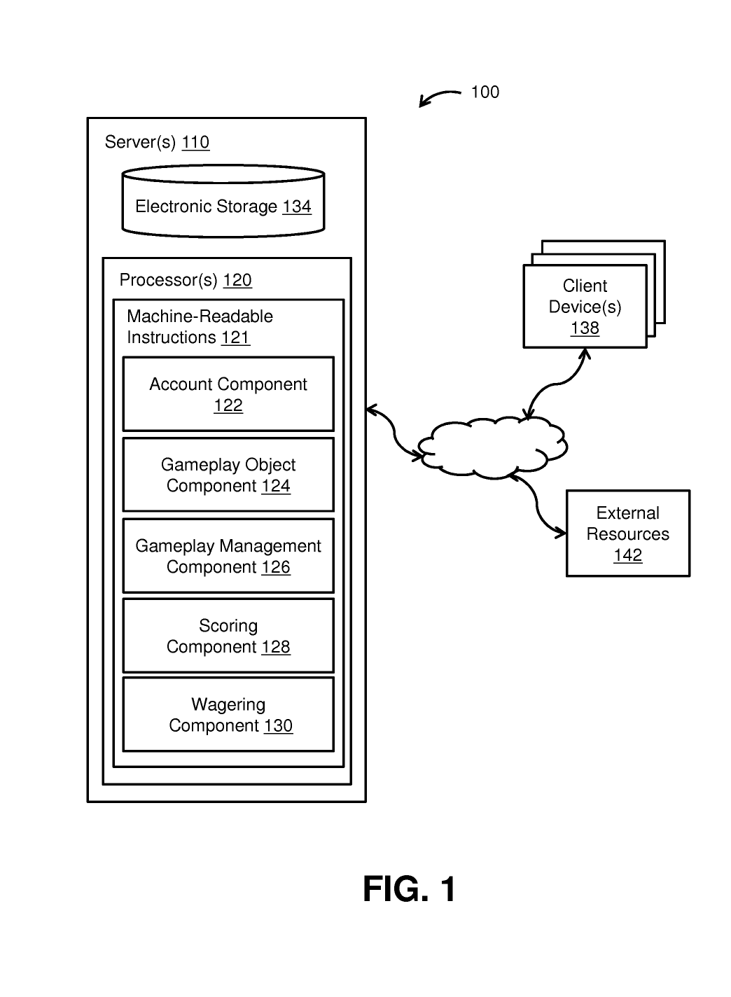

FIG. 1 illustrates a system 100 for providing an electronic game, in accordance with an embodiment. In some implementations, the game may include a card game and/or other type of game played with one or more of cards, tokens, and/or other gameplay objects. The card game may be played by multiple players. The players may play the game according to rules to achieve the goal of the game. By way of non-limiting example, the goal of the game may be to obtain the best (e.g., highest ranked) game spread which may include obtaining the strongest groupings of cards using the same set of cards as their opponent(s). In some implementations, rules of the game may provide that the same set of cards and/or other gameplay objects be distributed to each of the players playing the game. Thus, the outcome of the game may be based on skill and judgement instead of luck.

System 100 may include one or more server(s) 110. Server(s) 110 may be configured to communicate with client device(s) 138 according to a client/server architecture and/or other architectures. A user and/or player may access the system 100 and/or the game via client device(s) 138. The server(s) 110 may be configured to execute machine-readable instructions 121. Machine-readable instructions 121 may include one or more of an account component 122, a gameplay object component 124, a gameplay management component 126, a scoring component 128, a wagering component 130, and/or other components.

Account component 122 may be configured to manage player accounts. In some implementations, a player may have an account including account information. The account information may include, for example, name information, username information, password information, location information, demographic information, payment information, balance information, wagering information, game history information, preference information, and/or other information associated with a player. In some implementations, account component 122 may maintain player accounts for wagering. For example, account component 122 may include balance information such that, responsive to a player placing a wager and losing, account component 122 may be configured to decrease the balance of the player. In some implementations, system 100 may allow one player to play in multiple games at a given time against the same and/or different players. As such, account component 122 may keep track of present and/or past games in which a player is participating.

Gameplay object component 124 may be configured to determine sets of gameplay objects with which the game may be played. In some implementations, gameplay object component 124 may be configured to transmit gameplay object information over a network to indicate subsets of the gameplay objects to present to the players competing in the game. The gameplay objects may include an object with which the game is played. For example, the gameplay objects may include cards (e.g., virtual cards resembling those within a standard deck of cards), tokens, and/or other gameplay objects with which the game is played. In some implementations, the gameplay objects may be presented on client device(s) 138. The gameplay objects may include a face having one or more markings to distinguish one individual gameplay object from another. By way of non-limiting example, cards may include markings that indicate their suit (e.g., diamonds, hearts, clubs, spades, and/or other suits), color (e.g., black, red, and/or other colors), and/or value (e.g., face cards and numbered cards). The markings may be used to determine the permissible and/or optimal gameplay uses of each card and/or other gameplay object according to the rules of the game being played. For example, markings including numbers, letters, and/or icons may identify an individual card as being one of an Ace, 2, 3, 4, 5, 6, 7, 8, 9, 10, Jack, Queen, King, and/or other value, and/or identify the card as being of a suit selected from diamonds, clubs, hearts, spades, and/or other suits. In some implementations, the game may be played with gameplay objects having different markings that do not correspond to the standard suit, colors, and/or value markings of cards (e.g., standard playing cards).

In some implementations, gameplay object component 124 may determine a set of cards to be played for a particular round of a game. In some implementations, gameplay object component 124 may determine one or more identical sets of cards may be presented on client devices associated with players competing in the game. The sets of cards and/or other gameplay objects presented to all of the players competing against each other in the game may be the same. An individual set of cards and/or other gameplay objects may include any number of cards and/or gameplay objects. As such, luck may not be an outcome determinative factor in the game. Gameplay object component 124 may be configured to determine one or more sets of cards and/or other gameplay objects based on algorithm. In some implementations, to ensure the set of cards and/or other gameplay objects determined for each player are the same, the same algorithm may be used to determine a set of cards and/or other gameplay objects for each player. In some implementations, for example, a set of cards determined may include fewer cards than are in a physical 52-card deck. A set of cards and/or other gameplay objects may include a predetermined number of cards and/or other gameplay objects. The predetermined number of cards and/or other gameplay objects may be enough cards and/or other gameplay objects to play a single round and/or other subdivision of the game. In some implementations, one or more new sets of cards and/or other gameplay objects may be determined for each round and/or other subdivision of the game. In some implementations, for example, to ensure the same cards are not included in the new set of cards, the algorithm may include deck limitations that limit the cards that may be determined to be included in a set of cards to those which have not yet been included in a representative deck (e.g., the algorithm may ensure that the three of hearts is not included in the set of cards for three rounds in a row).

In some implementations, two players may play the game such that they may compete against each other and/or more than two players may play the game such that they may compete against each other and/or other players. In some implementations, a single set of cards may be presented and/or distributed to all of the players for each round of the game. In some implementations, by way of example, if two players are competing, two identical sets of cards may be determined by gameplay object component 124; if three players are competing, three identical sets of cards may be determined by gameplay object component 124; if four players are competing, four identical sets of cards may be determined by gameplay object component 124; and/or if a given number of players are competing, the given number of identical sets of cards may be determined by gameplay object component 124 for each round of the game.

Gameplay object component 124 may be configured to distribute the cards in the one or more sets of cards to the players in one or more identical subsets. In some implementations, gameplay object component 124 may transmit card information and/or other gameplay object information indicating subsets of the sets of cards and/or other gameplay objects to client device(s) 138. The card information and/or other gameplay object information may be transmitted over a network to client device(s) 138 for presentation on client device(s) 138. The subsets may include a predetermined number of cards and/or other gameplay objects from the set that are provided to a player at a given time. The subsets may include any number of cards and/or other gameplay objects less than or equal to the number of cards and/or other gameplay objects in the set. In some implementations, individual ones of multiple subsets may include different quantities of cards and/or other gameplay objects. By way of non-limiting example, a first subset may include five cards, a second subset may include three cards, a third subset may include three cards, a fourth subset may include three cards, and/or a fifth subset may include three cards. In some implementations, the cards and/or other gameplay objects included in the subset may indicate the cards and/or other gameplay objects that a player may use to play the game. In some implementations, the cards and/or other gameplay objects may be presented on one or more client device(s) 138 face-up such that the markings (e.g., numbers, colors, icons, and/or other markings) are displayed.

The number of cards and/or other gameplay objects in individual subsets may be predetermined. In some implementations, for example, there may be five subsets of a given set of cards. The number of cards and/or other gameplay objects included in individual subsets of a given set of cards and/or other gameplay objects may be predetermined. By way of non-limiting use example, 17 cards may be included in an individual set of cards and a first subset of the individual set of cards may include five cards, a second subset of the individual set of cards may include three cards, a third subset of the individual set of cards may include three cards, a fourth subset of the individual set of cards may include three cards, and/or a fifth subset of the individual set of cards may include three cards. In some implementations, a player may not be able to play (e.g., place within a game spread) all of the cards and/or other gameplay objects included in a given subset of the set of cards and/or other gameplay objects. For example, the game rules may require one or more cards in a given subset to be discarded.

In some implementations, the subsets of cards and/or other gameplay objects presented to individual ones of the players competing in the game may be the same. As such, for example, gameplay object component 124 may be configured to transmit the same card information indicating the same subsets of the sets cards to multiple client device(s) 138 associated with the players playing the game. In some implementations, the card information may include card order information indicating an order in which the cards in the subsets of the sets of cards are presented on client device(s) 138. In some implementations, gameplay object component 124 may be configured to transmit the same card order information indicating the same order in which the cards in the subsets of the set of cards are to be presented on a device, to multiple client device(s) 138 associated with the players playing the game. As such, for example, in some implementations the players may be presented with sets of cards that are the same and/or subsets of the sets of cards that are the same, all in the same order. In some implementations, the sets of cards may be the same, but the subsets of the sets of cards and/or the order in which the cards are presented may not be the same for all players competing in the game.

Gameplay management component 126 may be configured to receive game commands from each player in the game specifying how the player chooses to play one or more cards and/or other gameplay objects in the game. In some implementations, game play management component 126 may receive game commands over the network from client device(s) 138. The players may provide the game commands via client device(s) 138 and/or a device associated with the client device(s) 138. Game commands may indicate placing one or more cards and/or other gameplay objects included in the subsets into game spreads. The game spreads may include locations having slots in which players may place cards and/or other gameplay objects during gameplay. An individual game spread may be associated with an individual player such that the gameplay of the individual player is displayed in their game spread. The game commands may indicate where in the game spreads to place the cards and/or other gameplay objects. A game spread may have a predetermined number of locations. Individual locations may have predetermined numbers of slots for cards and/or other gameplay objects to be placed. By way of non-limiting example, the locations may include three rows where a back row has five slots (e.g., to hold five cards), a middle row has five slots, and a front row has three slots. The system may execute the game commands received by placing the cards and/or other gameplay objects into the game spreads. The cards and/or other gameplay objects may be placed into the game spreads in indicated slots within indicated locations (e.g., indicated by the game commands). Once the cards and/or other gameplay objects are placed into the game spreads, a player may indicate via a game command to set the cards and/or other gameplay objects as placed. In some implementations, once the cards and/or other gameplay objects are set in one or more slots within locations in the game spread, they may not be moved (e.g., a player may not be able to relocate and/or remove the set cards and/or other gameplay objects).

The game rules may indicate at what points throughout the game a player must and/or may set the cards and/or other gameplay objects placed in the game spreads. In some implementations, the rules of the game may indicate that a player has to place and/or set a predetermined number of cards and/or other gameplay objects in the game spread prior to being presented with another subset of the set of cards and/or other gameplay objects. As such, by way of non-limiting example, a player may have to place and/or set one or more cards at a time within the game spread without seeing all of the cards in the set of cards. In some implementations, the cards and/or other gameplay objects may be placed within the game spread face-up such that the markings (e.g., numbers, colors, icons, and/or other markings) are displayed on one or more client device(s) 138. In some implementations, rules of the game may indicate how many cards and/or other gameplay objects must be placed and/or how many cards and/or other gameplay objects must be discarded per subset of the set of cards and/or other gameplay objects. By way of non-limiting use example, a player may have to set the cards placed in the game spread after each placement of cards from a given subset and/or before being presented with the next subset.

A non-limiting example of the gameplay described herein according to example game rules is presented below. A first subset including five cards may be presented (e.g., dealt) to individual ones of the players. The individual players may be required to place all five cards in any of the open slots at any of the locations in their associated game spread. After the player has decided where to place the five cards in the first subset, those card positions may be set (e.g., locked in) by the player, and the player may not be able to rearrange those set cards. Thereafter, each player may be presented a second subset including three cards. Players may only be able to place two of the three cards in any of the remaining open slots at any of the locations in their associated game spread such that the third card is discarded. As with the first subset of five cards, once the player places and/or sets the two cards from each subset, the player cannot rearrange those set cards. In total, each player may be presented with one five-card subset and four three-card subsets for a total of 17 cards included in set of cards. The game spread may include two locations having five slots at each, and one location having three slots for a total of 13 slots and three locations. Thus, 13 of the 17 cards included in a set of cards may be placed (e.g., played) into two five-card groupings at a first and second location (e.g., hands) and one three-card grouping at a third location (e.g., hand). The remaining four cards may be the discarded cards. In some embodiments, players may be able to view their previously discarded cards. In other embodiments, a player cannot view any previously discarded cards.

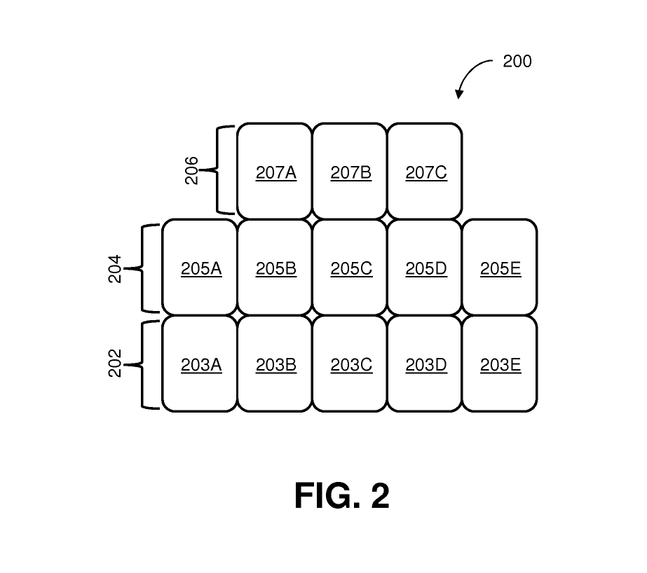

FIG. 2 illustrates a game spread 200, in accordance with an embodiment. Game spread 200 may include a predetermined number of locations. The predetermined number of locations may include a first location 202, a second location 204, a third location 206, and/or other locations. Individual locations may have predetermined numbers of slots in which cards may be placed. First location 202 may have first slots 203. By way of non-limiting example, first slots 203 may include five slots in which cards may be placed. Second location 204 may have second slots 205. By way of non-limiting example, second slots 205 may include five slots in which cards may be placed. Third location 206 may include third slots 207. By way of non-limiting example, third slots 207 may include three slots in which cards may be placed. Cards placed in first slots 203 may define a first grouping of cards at first location 202. Cards placed in second slots 205 may define a second grouping of cards at second location 204. Cards placed in third slots 207 may define a third grouping of cards at third location 206.

Returning to FIG. 1, gameplay management component 126 may be configured to effectuate presentation of one or more game spreads including the cards and/or other gameplay objects placed within the game spread. The game spreads may be presented on client device(s) 138 associated with the opposing player responsive to the gameplay management component 126 executing the game commands generated by the opposing player. In some implementations, responsive to executing given commands from a given player, a game spread associated with the given player may be presented on another client device(s) 138 associated with the opposing player by transmitting given game spread information indicating the given game spread over the network. The given game spread information indicating the given game spread may include the cards and/or other gameplay objects placed within the given game spread.

By way of non-limiting example, individual players may play (e.g., by placing via the game commands) 13 of the cards included in a set of 17 cards that may be presented in subsets, without waiting for the other player(s). Continuing the non-limiting example, the players may not see each other's progress while placing their cards and/or setting their game spreads. However, continuing the non-limiting example, if one player finishes placing his cards and setting his game spread before his opponent(s), the first player may have the option to view the remaining opponents' game spreads.

In some implementations, the subsets may partially define turns. As such, gameplay management component 126 may monitor turn information such that the players take turns placing cards and/or other gameplay objects included in each subset and/or alternate after each subset. In some implementations, for example, gameplay management component 126 may effectuate presentation of an opponent's game spread including the cards placed after the opponent places the cards (e.g., and/or sets the cards), and/or after the player places their cards from the current subset being presented/played. In some implementations, gameplay management component 126 may effectuate presentation of an opponent's game spread including the cards and/or other gameplay objects placed after both players have placed, discarded, and/or set all of the cards and/or other gameplay objects in the set and/or in a subset of the set of cards and/or other gameplay objects.

In some implementations, the turn information may indicate which player is a representative dealer. The representative dealer may be indicated by a virtual dealer coin that may be passed. Game rules may indicate the players alternate placing and/or setting one or more cards and/or other gameplay objects, and/or one or more subsets. As such, an ordering of turns and/or passing of the dealer coin may be tracked by gameplay management component 126 to ensure a consistent turn order rotation among the players. In some implementations, gameplay management component 126 may keep track of, through multiple game spreads, which player should be the representative dealer. A player's status as the representative dealer may be used to determine other game rules such as one or more of antes, wagering, game spread display, and/or other game features. By way of non-limiting example, the representative dealer may be a player that places one or more of his cards after his opponent has placed at least a subset of his cards such that his opponent's placed cards may be displayed while the player is determining where to place the same cards. Continuing the non-limiting example, the roles may be switched for the next round such that the opponent has the second turn and is able to view the cards placed by the player prior to placing his cards.

Scoring component 128 may be configured to determine scores for individual ones of the players. Scores may be based on an accumulation of points. The score determined may include a total score representing a base score, a bonus score, a negative score, and/or other scores earned per game and/or subdivision of the game. In some implementations, the scores may be determined after all of the subsets of the sets of cards and/or gameplay objects have been presented to the players, the cards and/or other gameplay objects within the sets of cards and/or other gameplay objects have been either placed or discarded, and/or the game spreads are complete and/or set. A complete and/or set game spread may include a full game spread having cards and/or other gameplay objects placed at the predetermined number of slots within the predetermined number of locations such that a player cannot change or move the cards and/or other gameplay objects. By way of non-limiting example, a complete game spread may include five cards placed at a first location (e.g., back row), five cards placed at a second location (e.g., middle row), and three cards placed at a third location (e.g., front row). Scores may be determined based on rankings of the game spreads. The rankings of the game may include rankings of the groupings of cards located at individual locations within the game spread. By way of non-limiting example, a grouping may include the cards placed in an individual row.

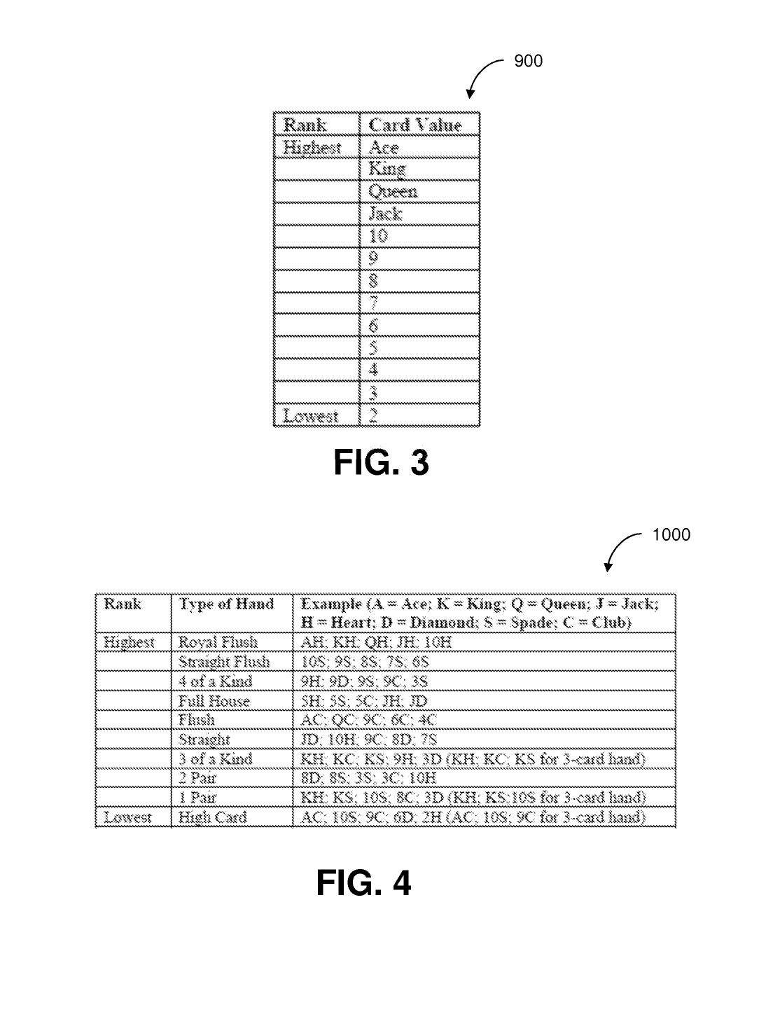

In some implementations, the game rules may indicate one or more requirements for game play. For example, a requirement may be to obtain a valid game spread set-up. As such, determining scores for the individual players may require first determining whether a given game spread has a valid game spread set-up, and if valid, scoring each grouping of cards and/or other gameplay objects at the locations within the given game spread. A valid game spread set-up may require the groupings to have a predetermined ranking order. By way of non-limiting example, a grouping of cards in the back row may be required to have a higher ranking than a grouping of cards in the middle row, and a grouping of cards in the middle row may be required have a higher ranking than a grouping of cards in the front row. A higher ranking may include a stronger grouping of cards and/or other gameplay objects wherein the strengths and/or rankings are determined according to one or more game rules. In some implementations, the strengths and/or rankings may be determined according to standard card rankings and/or card group rankings (see e.g., FIGS. 3 and 4 illustrating a standard card ranking table and a card grouping ranking table respectively). By way of non-limiting example, the strengths and/or rankings may be determined according to standard poker rankings. In some implementations, an invalid game spread set-up may be forfeited and/or cause an automatic loss to any opponent's game spread which has a valid game spread set-up. As such, the player with an invalid game spread may not qualify to receive a score for the round, may lose at least a predetermined score, and/or may be otherwise penalized.

By way of non-limiting example, according to example game rules, for a game spread having a back row that holds five cards, a middle row that holds five cards, and a third row that holds three cards, the back row must include a stronger grouping (e.g., be a stronger hand of cards) than the middle row, and the middle row must be a stronger grouping than the front row. If the player does not correctly set up a game spread (e.g., hand), the game spread may be considered to have an invalid game spread set-up (e.g., a fouled or mis-set hand). In some embodiments, for example, strength of a grouping is determined according to poker rankings and/or rules. Some ranking levels (e.g., a royal flush, a straight flush, four of a kind, full house, flush, and/or straight) may require a minimum number of cards and/or other gameplay objects. As such, a player may not be able to have a grouping with a given ranking level in row that has fewer card and/or other gameplay object slots than the minimum number of cards and/or other gameplay objects required for a given ranking level. For example, a royal flush, a straight flush, four of a kind, full house, flush, and/or straight may not be a legal ranking level of a grouping in the front row because the front row may only have three card slots which is fewer than the minimum number of cards required for a straight flush, four of a kind, full house, flush, and/or straight.

In some implementations, scoring component 128 may determine the scores at least partially based on relative rankings. Relative rankings may be based on a comparison between the groupings at corresponding locations in the players' game spreads. By way of non-limiting example, a ranking level of a first grouping at a first location (e.g., a strength of a hand of cards within the back row) in a first game spread associated with the first player may be compared to a ranking level of a first grouping at a first location (e.g., a hand of cards within the back row) in a second game spread associated with the second player to determine the higher relative ranking of the two game spreads. In some implementations, for each grouping having a higher relative ranking than a grouping at a corresponding location in an opponent's game spread, the player may earn a base score (e.g., a predetermined number of points per higher relative ranking).

A non-limiting use example of determining player's scores according to example game rules is presented below. To determine scores, players' rows (e.g., locations including groupings of cards) are compared to each other using standard card and/or card grouping rankings (see e.g., table 900 and table 1000 in FIGS. 3 and 4 respectively) and each row won (e.g., having the highest relative ranking) is worth one point. As such, a first player's back row may be compared to a second player's back row, the first player's middle row may be compared to the second player's middle row, and the first player's front row may be compared to the second player's front row. For determining which grouping included in the rows has a higher relative ranking, (e.g., which hand is better), the system may implement the following rules. In one embodiment, for example, an ace is the highest card and a “2” card is the lowest, although the ace may be used as the low card wherein it has a value of one. For any groupings that fall into the same category, the hand with the highest value cards wins. The following groupings provide an example ranking from strongest to weakest and are illustrated in FIG. 4: (1) A royal flush is a five-card grouping wherein the player has an ace, king, queen, jack, and ten, and all of the cards are the same suit; (2) a straight flush is a five-card grouping wherein the player has five cards in numerical order (excluding the combination of ace, king, queen, jack, and ten), and all of the cards are the same suit; (3) a four of a kind is a five-card grouping wherein the player has four cards of one rank and any other unmatched card; (4) a full house is a five-card grouping wherein the player has three cards of one rank and the remaining two cards are a pair of another rank; (5) a flush is a five-card grouping wherein all of the cards are of the same suit but are not in numerical order; (6) a straight is a five-card grouping wherein all of the cards are in numerical order but are not the same suit; (7) a three of a kind is a five-card grouping (or, for purposes of an implementation of the disclosed game, a three-card grouping) wherein the player has three cards of one rank and two other cards that do not match the first three or each other (if it is the player's three-card grouping, the player will not end up with two additional cards); (8) a two pair is a five-card grouping wherein the player has two cards of one rank and two cards of a different rank, the last card does not match either pair; (9) a one pair is a five-card grouping (or, for purposes of an implementation of the disclosed game, a three-card grouping) wherein the player has two cards of one rank and three additional cards that do not match the pair or each other (if it is the player's three-card grouping, the player will have two cards of one rank and one additional card that does not match the pair); and (10) a high card is a five-card grouping (or, for purposes of an implementation of the disclosed, a three-card grouping) that does not fall under any of the previous categories.

In some implementations, scoring component 128 may determine a bonus score (e.g., bonus points) to be provided to the player associated with a game spread including higher relative rankings for a predetermined number of groupings at a predetermined number of locations. For example, a player associated with a game spread having higher relative rankings for three groupings at three locations, wherein the game spread has slots for three groupings at three locations, may be provided with a bonus score.

By way of non-limiting example, according to example game rules, if one player wins (e.g., has the higher relative ranking) all three locations in a three-location game spread, that player has “scooped” the opponent and will receive a three-point bonus score. Continuing the non-limiting use example, the total score for the player may include six points (the three point bonus plus one point per higher relative ranking). By way of non-limiting example, if one player has an invalid game spread set-up (e.g., the game spread is mis-set), the opponent may automatically “scoop” the game spread (e.g., hand) and the player may lose and/or be penalized at least a predetermined score (e.g., the player may lose at least six points plus any other bonus score the opponent earns).

In some implementations, scoring component 128 may determine a bonus score (e.g., a royalty) for the individual players based on actual rankings and/or strength of a grouping at a given location. As long as a player has a valid game spread set-up, a bonus score may be determined for having a given grouping with a given ranking level at a given location. For example, it is less likely/easier to obtain a flush ranking level in the second location (e.g., the middle row) than in the first location (e.g., the back row) while maintaining a valid game spread set-up. As such, continuing the example, a second grouping in the second location with a flush ranking level may be worth more points than a first grouping in the first location with a flush ranking level.

By way of non-limiting example, according to example game rules, the following bonus scores may be determined for ranking levels at the locations described herein. For groupings in the first location (e.g., the back row): two points for a straight; four points for a flush; six points for a full house; 10 points for four of a kind; 15 points for a straight flush; and 25 points for a royal flush. For groupings in the second location (e.g., the middle row): two points for three of a kind; four points for a straight; eight points for a flush; 12 points for a full house; 20 points for four of a kind; 30 points for a straight flush; and 50 points for a royal flush. For groupings in the third location (e.g., the front row): one point for a pair of sixes; two points for a pair of sevens; three points for a pair of eights; four points for a pair of nines; five points for a pair of tens; six points for a pair of jacks; seven points for a pair of queens; eight points for a pair of kings; nine points for a pair of aces; 10 points for three twos; 11 points for three threes; 12 points for three fours; 13 points for three fives; 14 points for three sixes; 15 points for three sevens; 16 points for three eights; 17 points for three nines; 18 points for three tens; 19 points for three jacks; 20 points for three queens; 21 points for three kings; 22 points for three aces. The foregoing is one, non-limiting, example embodiment. Other scoring methods may be employed as well.

As such, in some implementations, the game scoring may be based on one or more of a valid game spread set-up, relative rankings comparing corresponding locations (e.g., rows) between game spreads of different players, actual rankings and/or strength of a grouping at a given location, and/or other factors. By way of non-limiting example, according to example game rules, the scoring may be zero-sum (e.g., if a first player and a second player are playing against each other: for each point the first player scores against the second player, the second player may lose a point and the first player may earn a point; and for each point the second player scores against the first player, the first player may lose a point and the second player may earn a point). As such, continuing the non-limiting example, a negative score may result from a player losing more points than that player possesses. Responsive to the score being determined by the system, scoring information indicating the score may be transmitted to the client devices for presentation to the players. For example, in some implementations, after the players have completed their game spreads by placing cards in the predetermined number of locations with the predetermined numbers of slots, a score may be determined for individual ones of the players based on the game spreads associated with individual ones of the players.

In some embodiments of the game, players may be limited by a pre-determined amount of time allotted for player decisions to place cards and/or other gameplay objects. In one embodiment, a player may have a limited amount of time to place one or more cards and/or other gameplay objects in a given subset of the set cards and/or other gameplay objects into the game spread. In another embodiment, a player may have a limited amount of overall time to place and/or discard all of the cards and/or other gameplay objects included in the set of cards and/or other gameplay objects and presented in the subsets of the set of cards and/or other gameplay objects. If a player runs out of time, the player's incomplete game spread may be scored and scoring component 128 may determine that the incomplete game spread has an invalid game spread set-up and/or that the player does not qualify to receive a score. By way of non-limiting example, a player may have five minutes to place and/or discard 17 cards included in a set of cards. If a player does not place and/or discard the cards and/or other gameplay objects within the allotted time, the player's game spread may be considered to have an invalid game spread set-up (e.g., a fouled or mis-set hand). The player with an invalid game spread set-up (e.g., due to an invalid ranking order of groupings, the player running out of time, and/or for other reasons) may forfeit their game spread causing an automatic loss to any opponent's game spread which has a valid game spread set-up. As such, the player with an invalid game spread may lose and/or be penalized at least a predetermined number of points. By way of non-limiting example, a player with an invalid game spread set-up may lose at least six points (e.g., three points for three higher relative rankings and three bonus points for scooping), plus any other bonus score their opponent earns. By way of non-limiting example, if player one has an invalid game-spread set up due to an invalid ranking order of the groupings in the game spread, and player two has an invalid game-spread set-up due to the pre-determined amount of time expiring prior to completing their game spread, neither player may earn a score and both game spreads may be forfeited.

In some embodiments, a game spread may qualify for a bonus round. In some embodiments, to achieve the bonus round, a player must have a grouping with at least a predetermined ranking level at a given location. By way of non-limiting example, the predetermined ranking level may include a pair of queens or better at the third location (e.g., front row). In some implementations, the bonus round may be part of the same round of the game in which a player qualified for the bonus round. In the bonus round, the previously placed cards and/or other gameplay objects may be cleared from the game spread and an icon indicating the bonus round may be displayed. In the bonus round, a player may be presented all of the cards and/or other gameplay objects within a set of cards at once and/or may place the cards and/or other gameplay objects in the predetermined numbers of slots within the predetermined number of locations in the game spread without having to set the game spread in-between placing the cards and/or other gameplay objects. In some embodiments, by way of example, the set of cards presented to the player in the bonus round may include 14 cards. As such, a player may place all of the cards presented into the game spread.

In some implementations, by way of example, the set of cards presented to the player in the bonus round may include 14, 15, 16, and/or 17 cards such that the player may discard one, two, three, and/or four cards, but may be able to see all of the cards in the set before choosing which to discard. In the bonus round, the other player or players not qualifying for the bonus round may be presented a set of cards and/or other gameplay objects in subsets as described herein. In some implementations, all of the cards and/or other gameplay objects in the set of cards and/or other gameplay objects presented to the player in the bonus round may be included in the set of cards and/or other gameplay objects presented in subsets to the player(s) that did not qualify for the bonus round. In some implementations, if two players qualify for a bonus round, they may be presented sets of cards and/or other gameplay objects that are the same. In some implementations, a player may have a limited amount of time to place the cards and/or other gameplay objects included in a card and/or other gameplay object set in the bonus round.

A player may qualify for double, triple, and/or other multiple bonus rounds if that player's bonus game spread has a grouping of at least a pre-determined ranking level at a given location. By way of non-limiting example, a bonus game spread having of a grouping of three of a kind in the third location (e.g., the front row), and/or other pre-determined ranking level(s) at one or more pre-determined location(s) (e.g., the front row, the middle row, and/or the back row) may qualify for double, triple and/or other multiple bonus rounds. The double, triple, and/or other multiple bonus rounds may be played according to game rules that are the same as or similar to the game rules for the bonus round and/or one or more implementations of example game rules as described herein. In addition, to qualify for a bonus round, double bonus round, triple bonus round, and/or other multiple bonus rounds, the game spread must have a valid game spread set-up.

In some implementations, wagering component 130 may be configured to receive wager information over the network from client device(s) 138. The wagering information may indicate an amount of consideration (e.g., money) the first player and/or the second player wants to wager on the game and/or a subdivision of the game. Based on the outcome and/or results of the game and/or a subdivision of the game, a wager may be won or lost. Wagering component 130 may be configured to move consideration between player accounts based on the wager information, the scores of individual ones of the players determined for the game and/or the subdivision of the game, and/or other information.

In some embodiments, wagers may be placed before the game starts, after a subdivision of the game (e.g., a round and/or the placing/setting of a grouping and/or other subdivision), at the beginning of a subdivision, and/or at other points in the game. In some embodiments, the wager may include an agreed-upon dollar amount corresponding to the score (e.g., per points won such that $1.00 per point would result in the winner receiving $5.00 if they won by five points). In some implementations, wagering component 130 may move the consideration (e.g., settle up) at the end of each round (e.g., hand). In some embodiments, the players may agree to play a specified number of rounds (e.g., hands) and then settle up once all the rounds have been played.

In some implementations, where one player has more wager money available than the other player, a short stack rule may be implemented. The short stack rule may limit the amount the player with less wager money available is able to win. In some implementations, the player with the smaller amount of money (i.e., short stack) to wager may be able to win, at most, his own stack amount from each opponent in the round (e.g., hand). By way of non-limiting example, if a first player can wager $100 and a second player can wager $200, the first player can only win up to $100. In another example, if a first player can wager $100 and second and third players can wager $200 each, the first player can win up to $100 from each player for total winnings of $200. In some implementations, the player with the smaller amount of money (i.e., short stack) to wager may be able to win more than his own stack amount from one or more opponent(s) in the round (e.g., hand). By way of non-limiting example, if a first player can wager $100 and second and third players can wager $200 each, the first player may be able to win $100 from the second player and $200 from the third player, for total winnings of $300. Continuing the non-limiting example, if the first player qualifies for a bonus round based on the round in which they won $300, the first player's new amount of wager money (e.g., $400 total) may be used to determine the most the first player can win.

In some embodiments, the players may ante before a round (e.g., hand), wherein each player must pay a wager fee. The ante may be a flat amount or it may scale up based on stakes upon which the players have agreed. For example, the players may decide that each player must ante $1.00 per round. At the end of the round, the player who wins may collect the ante. In some embodiments, an ante may not be played if any player is in a bonus round, which is described further herein. As the bonus round may be a continuation of the round that qualified for the bonus round, another and/or new ante may not be required.

In some implementations, server(s) 110, client device(s) 138, and/or external resources 142 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 110, client device(s) 138, and/or external resources 142 may be operatively linked via some other communication media.

A given client device 138 may include one or more processors configured to execute machine-readable instructions 121. The computer program components may be configured to enable an expert, user, and/or player associated with the given client device 138 to interface with system 100 and/or external resources 142, and/or provide other functionality attributed herein to client device(s) 138. As such, one or more functions performed herein by server(s) 110 may be performed at one or more client device(s) 138. By way of non-limiting example, client device(s) 138 may include one or more of a desktop computer, a laptop computer, a handheld computer, a Netbook, a Smartphone, a gaming console, a gaming cabinet, a video gaming terminal, and/or other client device(s).

External resources 142 may include sources of information, hosts and/or providers of virtual environments outside of system 100, external entities participating with system 100, and/or other resources. In some implementations, some or all of the functionality attributed herein to external resources 142 may be provided by resources included in system 100.

The server(s) 110 may include electronic storage 134, one or more processor(s) 120, and/or other components. The server(s) 110 may include communication lines, or ports to enable the exchange of information with a network and/or other computing platforms. Illustration of server(s) 110 in FIG. 1 is not intended to be limiting. The server(s) 110 may include a plurality of hardware, software, and/or firmware components operating together to provide the functionality attributed herein to server(s) 110. For example, server(s) 110 may be implemented by a cloud of computing platforms operating together as server(s) 110.

Electronic storage 134 may comprise electronic storage media that electronically stores information. The electronic storage media of electronic storage 134 may include one or both of system storage that is provided integrally (i.e., substantially non-removable) with server(s) 110 and/or removable storage that is removably connectable to server(s) 110 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 134 may include one or more virtual storage resources (e.g., cloud storage, a virtual private network, and/or other virtual storage resources). Electronic storage 134 may store software algorithms, information determined by processor(s) 120, information received from server(s) 110, information received from client device(s) 138, and/or other information that enables server(s) 110 to function as described herein.

The processor(s) 120 may be configured to provide information-processing capabilities in server(s) 110. As such, processor(s) 120 may include one or more of a digital processor, an analog processor, a digital circuit designed to process information, an analog circuit designed to process information, a state machine, and/or other mechanisms for electronically processing information. Although processor(s) 120 is shown in FIG. 1 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. The processor(s) 120 may be configured to execute machine-readable instructions 121. Machine-readable instructions 121 may include components 122, 124, 126, 128, 130, and/or other components. The processor(s) 120 may be configured to execute components 122, 124, 126, 128, 130, and/or other components by software; hardware; firmware; some combination of software, hardware, and/or firmware; and/or other mechanisms for configuring processing capabilities on processor(s) 120.

It should be appreciated that although components 122, 124, 126, 128, and 130 are illustrated in FIG. 1 as being co-located within a single processing unit, in implementations in which processor(s) 120 includes multiple processing units, one or more of components 122, 124, 126, 128, and/or 130 may be located remotely from the other components. The description of the functionality provided by the different components 122, 124, 126, 128, and/or 130 described herein is for illustrative purposes, and is not intended to be limiting, as any of components 122, 124, 126, 128, and/or 130 may provide more or less functionality than is described. For example, one or more of components 122, 124, 126, 128, and/or 130 may be eliminated, and some or all of its functionality may be provided by other ones of components 122, 124, 126, 128, and/or 130. As another example, processor(s) 120 may be configured to execute one or more additional components that may perform some or all of the functionality attributed herein to one of components 122, 124, 126, 128, and/or 130. As another example, client device(s) 138 may include one or more processors configured to execute one or more additional components that may perform some or all of the functionality attributed herein to one of components 122, 124, 126, 128, and/or 130.

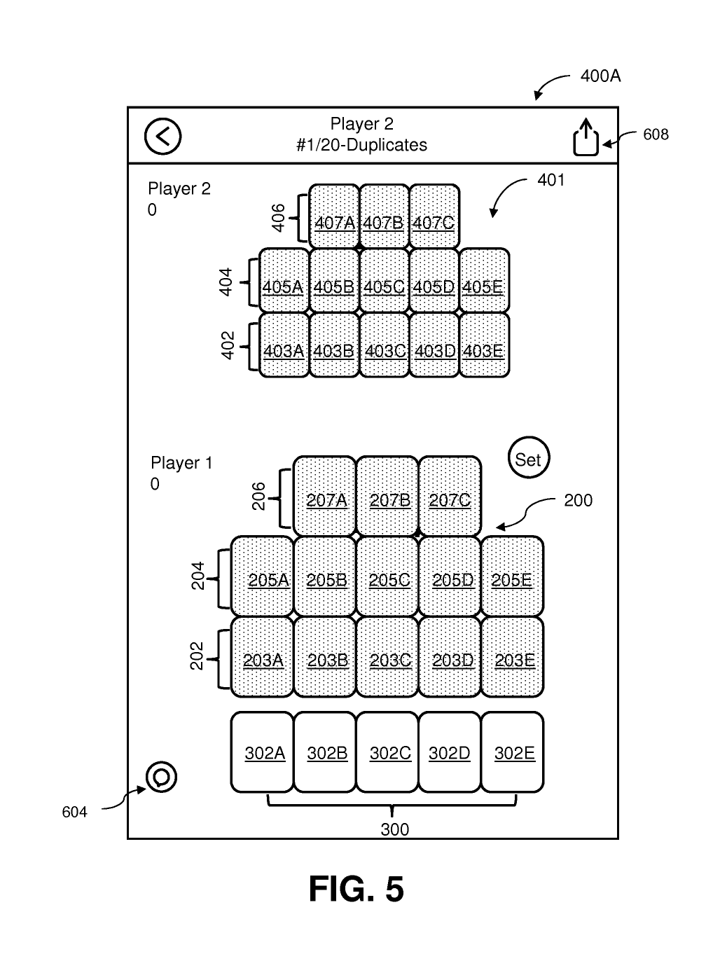

In some implementations, the game may be presented on one or more client device(s) 138 associated with the players competing in the game via a graphical user interface. FIGS. 5-9 illustrate a graphical user interface through which the game is presented on client device(s) 138, in accordance with an embodiment. As illustrated in FIGS. 5-9, graphical user interface 400 may present two game spreads associated with two players. Game spread 200 may be associated with Player One and game spread 401 may be associated with Player Two. As illustrated in FIG. 5, game spread 200 may include first location 202 (e.g., back row), second location 204 (e.g., middle row), third location 206 (e.g., front row), and/or other locations. First location 202 may have first slots 203, second location 204 may have second slots 205, and third location 206 may have third slots 207. Player Two may be associated with game spread 401. Game spread 401 may include a first location 402 (e.g., back row), a second location 404 (e.g., middle row), a third location 406 (e.g., front row), and/or other locations. First location 402 may have first slots 403, second location 404 may have second slots 405, and third location 406 may have third slots 407. A first subset 300 of a set of cards may be presented to Player One via graphical user interface 400. First subset 300 may include five cards 302 included in a first set of cards that are presented to Player One in first subset 300.

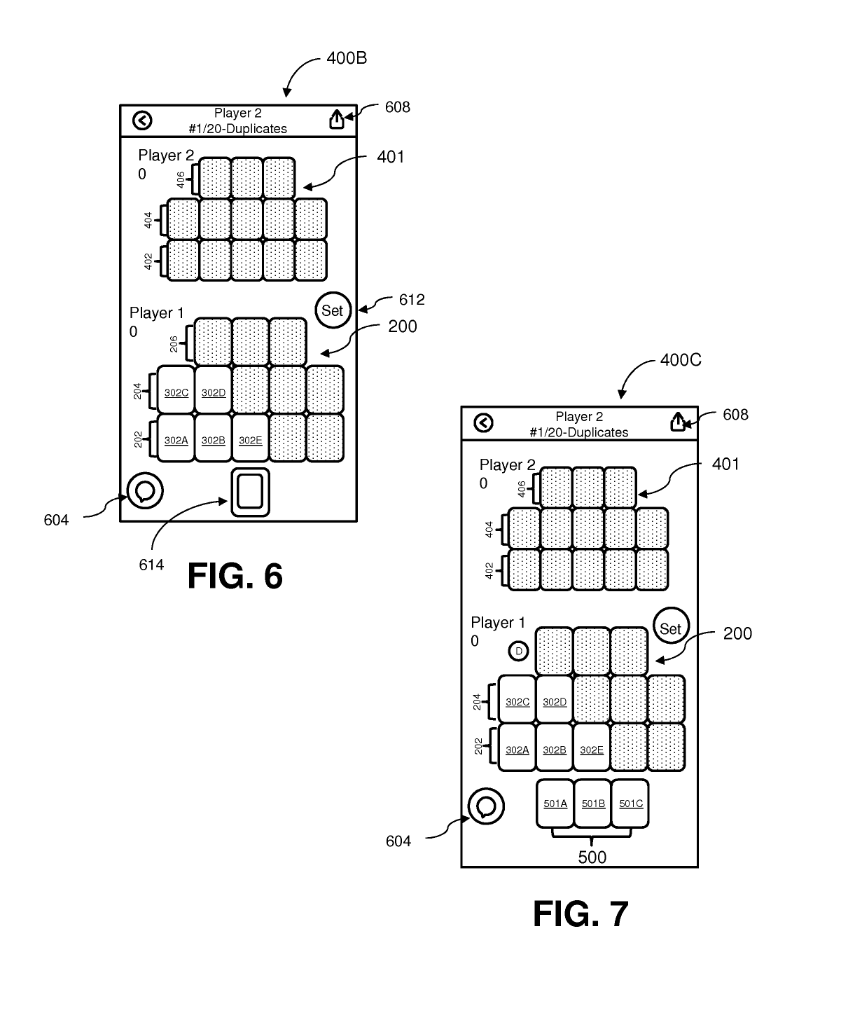

As illustrated in FIG. 6, as the game progresses, graphical user interface 400B may present the placement of one or more cards 302 by Player One. By way of non-limiting example, graphical user interface 400B presents all five cards 302 (included in subset 300 in graphical user interface 400A) placed within game spread 200. Card 302A, card 302B, and card 302E may be presented as placed in location 202 at previously displayed slot 203A, slot 203B, and slot 203C respectively (see e.g., FIG. 5). Card 302C and card 302D may be presented as placed in location 204 at previously displayed slot 205A and slot 205B respectively (see e.g., FIG. 5). To set (e.g., such that the locations may not be changed) the placement of cards 302, Player One may indicate a game command via set button 612 to set the cards.

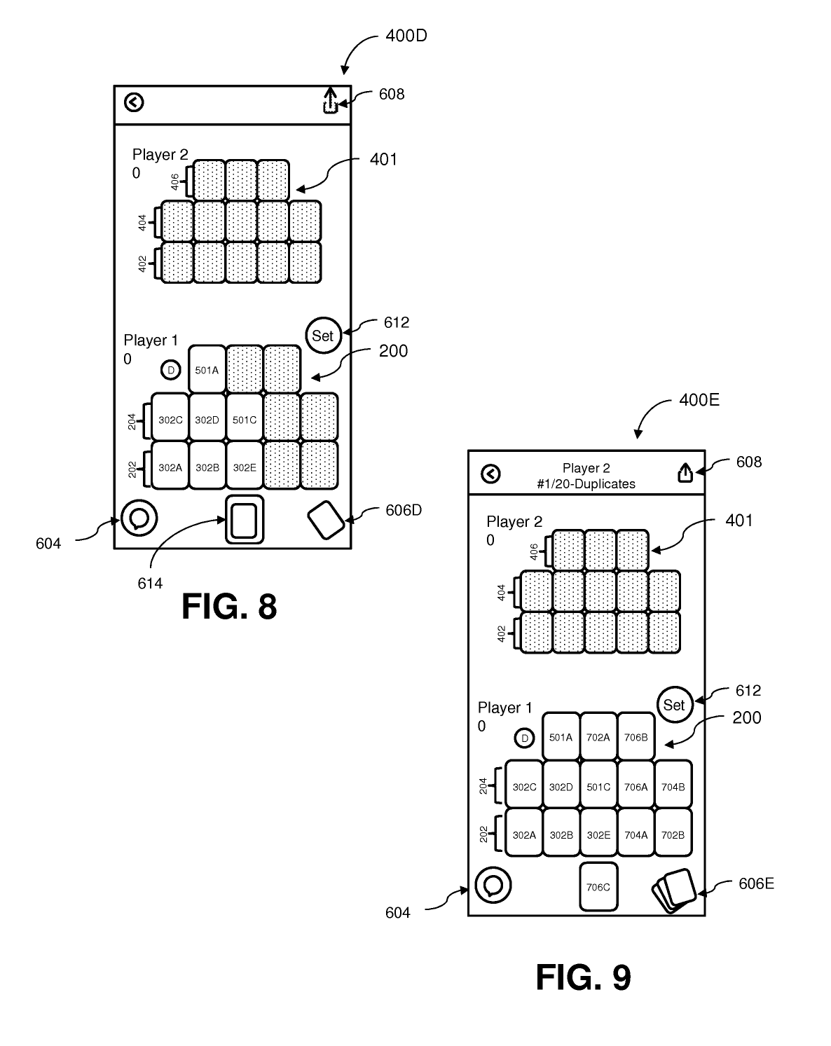

As illustrated in FIG. 7, graphical user interface 400C may present a second subset 500 of the set of cards to Player One in response to Player One setting previously placed cards 302. Subset 500 may include three cards 501. As illustrated in FIG. 8, graphical user interface 400D may present cards 501 as placed in game spread 200. Card 501A and card 501C may be presented as placed in location 204 and location 206 respectively at previously displayed slot 205C and slot 207A respectively (see e.g., FIG. 6).

One or more subsets of cards may be presented and/or placed until all of the cards in the set of cards have been presented and/or a predetermined number of slots at a predetermined number of locations have been filled with placed cards. As illustrated in FIG. 9, graphical user interface 400E may display a completed game spread 200. Five cards 302 from the first subset (e.g., subset 300), two cards 501 from the second subset (e.g., subset 500), two cards 702 from a third subset, two cards 704 from a fourth subset, and two cards 706 from a fifth subset may be placed within completed game spread 200. As such, to end the game spread, view Player Two's game spread, and discard card 706C, Player One may set completed game spread 200. Set button 612 may be touched by Player One to indicate a game command to set the completed game spread. In graphical user interface 400, illustrated in FIGS. 5-9, cards (e.g., cards 302, cards 501, cards 702, cards 704, and/or cards 706) may be presented to Player One and/or displayed as placed within game spread 200 in face-up manner such that the markings (e.g., numbers, colors, icons, and/or other markings) are visible to Player One.

In some implementations, each player in the game and/or example graphical user interfaces (e.g., graphical user interface 400 as illustrated in FIGS. 5-9) may be represented visually by a username, avatar, and/or icon of their choice. Next to each player's username, avatar, and/or icon that player's current score in the game may be displayed. In some implementations, the graphical user interface (see e.g., graphical user interface 400 as illustrated in FIGS. 5-9) may include a chat icon 604 indicating an interactive chat feature. The game may enable direct text communication between players. In some implementations, a graphical user interface may include a discard pile 606 (see e.g., graphical user interface 400D and 400E as illustrated in FIGS. 8 and 9). By way of non-limiting example, touching the screen in the location of discard pile 606 in the graphical user interface may cause the graphical user interface to display the individual discarded cards. In some implementations, the graphical user interface may be shared by touching a share button 608 (see e.g., graphical user interface 400 as illustrated in FIGS. 5-9). This may cause the client device presenting the graphical user interface to capture an image of the graphical user interface for sharing with third parties. One or more buttons permitting the player to return to a prior screen (e.g., that lists active games) may be included in the graphical user interface. One or more game control buttons may also be included in the graphical user interfaces. For example, one or more game control buttons may include a card button 614 enabling the user to initiate the display of a new set and/or subset of cards (see e.g., graphical user interface 400 as illustrated in FIGS. 6 and 8), a new round button to start a new round and/or game spread, and/or other game control buttons. The example graphical user interfaces described here are not intended to be limiting and may include additional features and/or include a limited number of the features described herein.

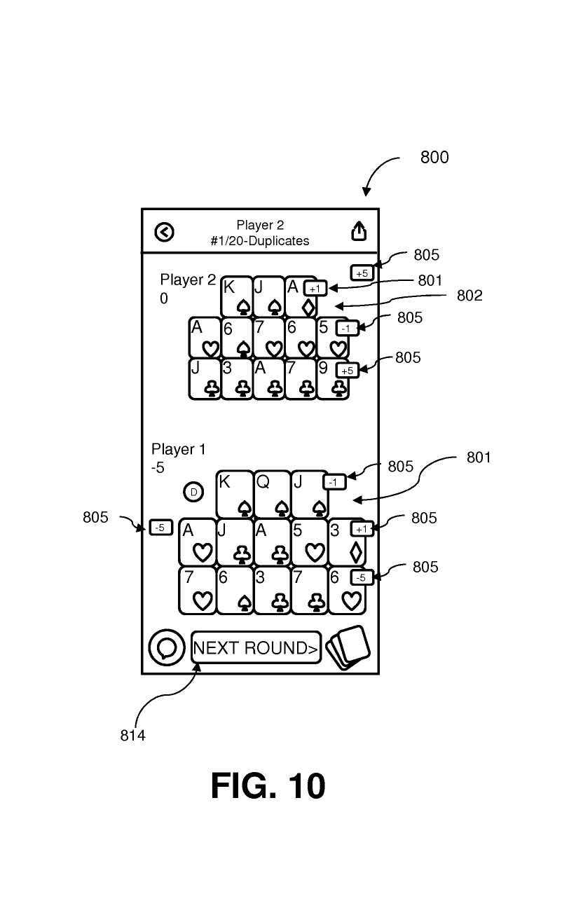

FIG. 10 illustrates a graphical user interface 800 through which the game is presented on a client device. Responsive to both players completing and/or setting their associated game spreads, game spread 801 associated with a Player One and game spread 802 associated with a Player Two may be presented via graphical user interface 800. Scores 805 may be displayed by graphical user interface 800 via one or more icons. Graphical user interface 800 a new round button 814 that a player may press/touch to initiate starting a new round and/or game spread. As illustrated in FIG. 10, both players may have received the same set of cards to place with their associated game spread. However, as illustrated in FIG. 10, players may place one or more cards within the game spread at different locations, and/or choose different discard cards, causing the game spreads and/or groupings within the game spreads to be different. As such, even though the same cards may be distributed to the players (and in some implementations, in the same order), the game spreads and scores based on the game spreads may be different.

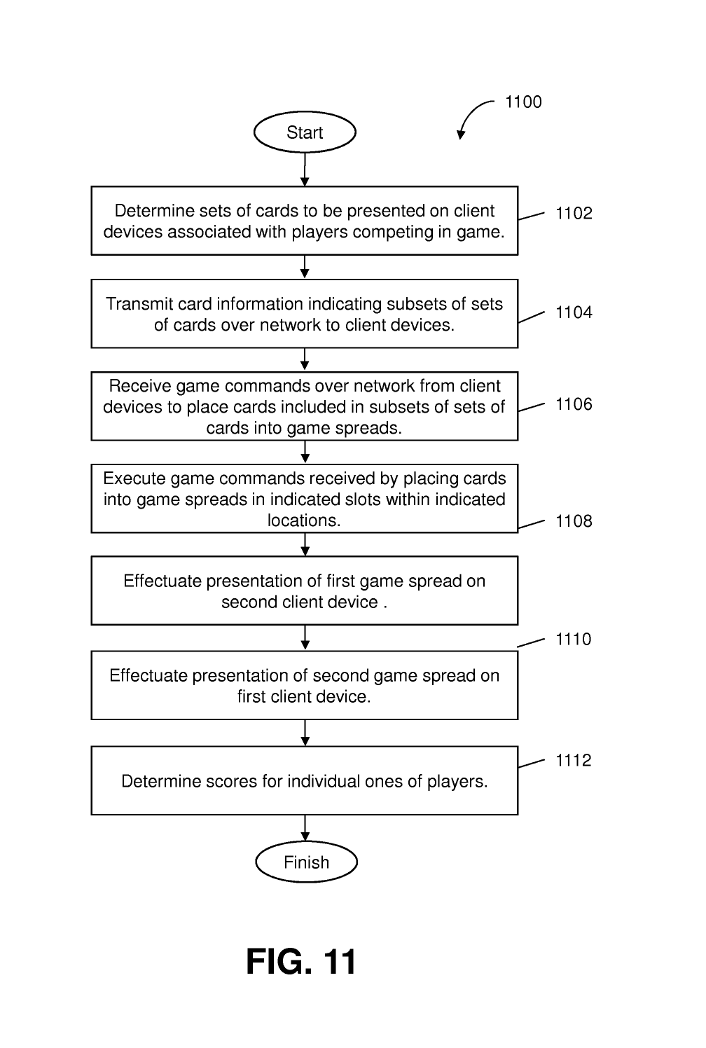

FIG. 11 illustrates a method 1100 for providing an electronic game, in accordance with one or more implementations. The operations of method 1100 presented below are intended to be illustrative. In some implementations, method 1100 may be accomplished with one or more additional operations not described, and/or without one or more of the operations discussed. Additionally, the order in which the operations of method 1100 are illustrated in FIG. 11 and described below is not intended to be limiting.

In some implementations, method 1100 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1100 in response to instructions stored electronically on an electronic storage medium. The one or more processing devices may include one or more devices configured through hardware, firmware, and/or software to be specifically designed for execution of one or more of the operations of method 1100.

At an operation 1102, sets of cards to be presented to players may be determined. In some implementations, the sets of cards may include sets of gameplay objects. The sets of cards determined may be for presentation on client devices associated with players competing in a game. The sets of cards may include a first set of cards to be presented on a first client device associated with a first player and/or a second set of cards to be presented on a second client device associated with a second player. The first set of cards and the second set of cards may be the same. Operation 1102 may be performed by a gameplay object component that is the same as or similar to gameplay object component 124, in accordance with one or more implementations.

At an operation 1104, card information indicating subsets of the sets of cards may be transmitted over a network to the client devices. In some implementations, the subsets of the sets of cards may include subsets of the sets of gameplay objects. The subsets of the sets of cards may be presented on the client devices. First card information indicating a first subset of the first set of cards may be transmitted to the first client device associated with the first player such that the first subset of the first set of cards may be presented on the first client device. Second card information indicating a second subset of the second set of cards may be transmitted to the second client device associated with the second player such that the second subset of the second set of cards may be presented on the first client device. Operation 1104 may be performed by a gameplay object component that is the same as or similar to gameplay object component 124, in accordance with one or more implementations.

At an operation 1106, game commands may be received. The game commands may be to place cards included in the subsets of the sets of cards into game spreads. The game commands may be received over the network from the client devices. The game spreads may have a predetermined number of locations. Individual locations may have predetermined numbers of slots. Individual game spreads may include groupings of cards defined by slots within the individual locations such that an individual grouping includes the cards placed in the slots within an individual location in an individual game spread. Operation 1106 may be performed by a gameplay management component that is the same as or similar to gameplay management component 126, in accordance with one or more implementations.

At an operation 1108, the game commands received may be executed. The game commands may be executed by placing the cards into the game spreads in indicated slots within indicated locations. The executed game commands may include first commands from the first client device to place the cards included in the first subset of the first set of cards into the first game spread in first indicated slots within first indicated locations defined by the first commands. The executed game commands may include second commands from the second client device to place the cards included in the first subset of the second set of cards into the second game spread in second indicated slots within second indicated locations defined by the second commands. Operation 1108 may be performed by a gameplay management component that is the same as or similar to gameplay management component 126, in accordance with one or more implementations.

At an operation 1110, presentation of the first game spread on the second client device may be effectuated. Presentation of the first game spread on the second client device may be effectuated responsive to executing the first commands. Presentation may be effectuated by transmitting first game spread information indicating the first game spread over the network. First game spread information may include the cards placed within the first game spread. As such, that first game spread may be visible to the second player. Operation 1110 may be performed by a gameplay management component that is the same as or similar to gameplay management component 126, in accordance with one or more implementations.

At an operation 1112, presentation of the second game spread on the first client device may be effectuated. Presentation of the second game spread on the first client device may be effectuated responsive to executing the second commands. Presentation may be effectuated by transmitting second game spread information indicating the second game spread over the network. Second game spread information may include the cards placed within the second game spread. As such, that second game spread may be visible to the first player. Operation 1112 may be performed by a gameplay management component that is the same as or similar to gameplay management component 126, in accordance with one or more implementations.

At an operation 1114, scores for individual ones of the players may be determined. The scores may be determined responsive to the card information indicating a predetermined number of the subsets of the sets of cards being transmitted to the client devices and/or the game spreads being complete such that the cards have been placed in the predetermined numbers of slots within the predetermined number of locations. The scores may be determined based on rankings of the game spreads. Operation 1114 may be performed by a scoring component that is the same as or similar to scoring component 128, in accordance with one or more implementations.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system for providing an electronic game, the system comprising:
physical computer processors configured by machine-readable instructions to:
determine sets of cards to be presented on client devices associated with players competing in an individual game against each other, the sets of cards including a first set of cards to be presented on a first client device associated with a first player and a second set of cards to be presented on a second client device associated with a second player, wherein the first set of cards and the second set of cards are the same such that the first player and the second player are competing against each other in the individual game with the sets of cards that are the same;
transmit card information indicating subsets of the sets of cards over a network to the client devices such that the subsets of the sets of cards are presented on the client devices, wherein first card information indicating a first subset of the first set of cards is transmitted to and presented on the first client device associated with the first player, and second card information indicating a first subset of the second set of cards is transmitted to and presented on the second client device associated with the second player;
receive game commands over the network from the client devices to place cards included in the subsets of the sets of cards into game spreads, the game spreads having a predetermined number of locations and individual locations having predetermined numbers of slots, wherein individual game spreads include groupings of cards defined by slots within the individual locations such that an individual grouping includes the cards placed in the slots within an individual location in an individual game spread;
execute the game commands received by placing the cards into the game spreads in indicated slots within indicated locations, the executed game commands including first commands from the first client device to place the cards included in the first subset of the first set of cards into the first game spread in first indicated slots within first indicated locations defined by the first commands, and second commands from the second client device to place the cards included in the first subset of the second set of cards into the second game spread in second indicated slots within second indicated locations defined by the second commands;
effectuate presentation, responsive to executing the first commands, of the first game spread on the second client device by transmitting first game spread information indicating the first game spread, including the cards placed within the first game spread, over the network such that first game spread is visible to the second player;
effectuate presentation, responsive to executing the second commands, of the second game spread on the first client device by transmitting second game spread information indicating the second game spread, including the cards placed within the second game spread, over the network such that second game spread is visible to the first player;
determine, responsive to the card information indicating a predetermined number of the subsets of the sets of cards being transmitted to the client devices and the game spreads being complete such that the cards have been placed in the predetermined numbers of slots within the predetermined number of locations, scores for individual ones of the players, wherein the scores are determined based on rankings of the game spreads compared to each other such that the first game spread including some cards from the first set of cards is directly compared to the second game spread including some cards from the second set of cards, and wherein the first game spread and the second game spread include at least one card that is the same.

2. The system of claim 1, wherein determining scores for the individual ones of the players further includes:
determining whether the game spreads have a valid game spread set-up, the valid game spread set-up requiring the groupings of cards included in the individual game spreads to have a predetermined ranking order, the groupings included in the individual game spreads including a first grouping included at a first location in the individual game spreads, a second grouping included at a second location in the individual game spreads, and a third grouping included at a third location in the individual game spreads, wherein the predetermined ranking order for the valid game spread set-up requires that a first ranking associated with the first grouping is higher than a second ranking associated with the second grouping, and the second ranking associated with the second grouping is higher than the third ranking associated with the third grouping.

3. The system of claim 2, wherein determining scores for the individual ones of the players further includes:
determining, responsive to the game spreads having the valid game spread set-up, relative rankings for corresponding groupings of cards included in corresponding locations in the individual game spreads, wherein a first relative ranking is based on a comparison between a first grouping at a first location in the first game spread and a first grouping at a first location in the second game spread such that responsive to the first grouping at the first location in the first game spread having a higher relative ranking than the first grouping at the first location in the second game spread, a higher score is determined for the first player.

4. The system of claim 3, wherein the physical computer processors are further configured by machine readable instructions to:
provide, responsive to one of the first game spread or the second game spread including higher relative rankings for a predetermined number of groupings at the predetermined number of locations within the individual game spreads, a bonus score to the first player or the second player.

5. The system of claim 1, wherein the first subset of the first set of cards includes five cards and the first subset of the second set of cards includes the same five cards.

6. (canceled)

7. The system of claim 1, wherein the subsets of the sets of cards indicated by the card information transmitted to the players further include: a second subset of the first set of cards and a second subset of the second set of cards; a third subset of the first set of cards and a third subset of the second set of cards; a fourth subset of the first set of cards and a fourth subset of the second set of cards; and a fifth subset of the first set of cards and a fifth subset of the second set of cards wherein the second subset, the third subset, the fourth subset, and the fifth subset of the first set of cards include three cards that are the same three cards included in the second subset, the third subset, the fourth subset, and the fifth subset of the second set of cards.

8. (canceled)

9. The system of claim 8, wherein two of three cards included in individual ones of the second, third, fourth, and fifth subsets of the first and second sets of cards are placed based on the game commands, and one of three cards included in individual ones of the second, third, fourth, and fifth subsets of the first and second sets of cards is discarded based on the game commands.

10. The system of claim 1, wherein the first card information and the second card information indicate the same subsets of the sets cards and wherein the card information includes card order information indicating an order in which the cards in the subsets of the sets of cards are presented on the client devices, the first card information including first card order information indicating the order in which the cards in the first subset of the first set of cards are presented on the first device, and the second card information including second card order information indicating the order in which the cards in the first subset of the second set of cards are presented on the second device, wherein the first card order information and the second card order indicate the same order.

11. The system of claim 1, wherein the physical computer processors are further configured by machine-readable instructions to:
receive wager information over the network from the client devices indicating an amount of consideration the first player or the second player wants to wager on the game or a subdivision of the game; and
move consideration between player accounts based on the wager information and the scores of individual ones of the players determined for the game or the subdivision of the game.

12. A method for providing an electronic game, the method being implemented on a computer system having one or more physical processors configured by machine-readable instructions which, when executed, perform the method, the method comprising:
determining, by the computer system, sets of cards to be presented on client devices associated with players competing in an individual game against each other, the sets of cards including a first set of cards to be presented on a first client device associated with a first player and a second set of cards to be presented on a second client device associated with a second player, wherein the first set of cards and the second set of cards are the same such that the first player and the second player are competing against each other in the individual game with the sets of cards that are the same;
transmitting, by the computer system, card information indicating subsets of the sets of cards over a network to the client devices such that the subsets of the sets of cards are presented on the client devices, wherein first card information indicating a first subset of the first set of cards is transmitted to and presented on the first client device associated with the first player, and second card information indicating a first subset of the second set of cards is transmitted to and presented on the second client device associated with the second player;
receiving, at the computer system, game commands over the network from the client devices to place cards included in the subsets of the sets of cards into game spreads, the game spreads having a predetermined number of locations and individual locations having predetermined numbers of slots, wherein individual game spreads include groupings of cards defined by slots within the individual locations such that an individual grouping includes the cards placed in the slots within an individual location in an individual game spread;
executing, by the computer system, the game commands received by placing the cards into the game spreads in indicated slots within indicated locations, the executed game commands including first commands from the first client device to place the cards included in the first subset of the first set of cards into the first game spread in first indicated slots within first indicated locations defined by the first commands, and second commands from the second client device to place the cards included in the first subset of the second set of cards into the second game spread in second indicated slots within second indicated locations defined by the second commands;
effectuating presentation, by the computer system, responsive to executing the first commands, of the first game spread on the second client device by transmitting first game spread information indicating the first game spread, including the cards placed within the first game spread, over the network such that first game spread is visible to the second player;
effectuating presentation, by the computer system, responsive to executing the second commands, of the second game spread on the first client device by transmitting second game spread information indicating the second game spread, including the cards placed within the second game spread, over the network such that second game spread is visible to the first player;
determining, by the computer system, responsive to the card information indicating a predetermined number of the subsets of the sets of cards being transmitted to the client devices and the game spreads being complete such that the cards have been placed in the predetermined numbers of slots within the predetermined number of locations, scores for individual ones of the players, wherein the scores are determined based on rankings of the game spreads compared to each other such that the first game spread including some cards from the first set of cards is directly compared to the second game spread including some cards from the second set of cards, and wherein the first game spread and the second game spread include at least one card that is the same.

13. The method of claim 12, wherein determining scores for the individual ones of the players further includes:
determining whether the game spreads have a valid game spread set-up, the valid game spread set-up requiring the groupings of cards included in the individual game spreads to have a predetermined ranking order, the groupings included in the individual game spreads including a first grouping included at a first location in the individual game spreads, a second grouping included at a second location in the individual game spreads, and a third grouping included at a third location in the individual game spreads, wherein the predetermined ranking order for the valid game spread set-up requires that a first ranking associated with the first grouping is higher than a second ranking associated with the second grouping, and the second ranking associated with the second grouping is higher than the third ranking associated with the third grouping.

14. The method of claim 13, wherein determining scores for the individual ones of the players further includes:
determining, responsive to the game spreads having the valid game spread set-up, relative rankings for corresponding groupings of cards included in corresponding locations in the individual game spreads, wherein a first relative ranking is based on a comparison between a first grouping at a first location in the first game spread and a first grouping at a first location in the second game spread such that responsive to the first grouping at the first location in the first game spread having a higher relative ranking than the first grouping at the first location in the second game spread, a higher score is determined for the first player.

15. The method of claim 14, further comprising:
providing, by the computer system, responsive to one of the first game spread or the second game spread including higher relative rankings for a predetermined number of groupings at the predetermined number of locations within the individual game spreads, a bonus score to the first player or the second player.

16. The method of claim 12, wherein the first subset of the first set of cards includes five cards and the first subset of the second set of cards includes the same five cards.

17. (canceled)

18. The method of claim 12, wherein the subsets of the sets of cards indicated by the card information transmitted to the players further include: a second subset of the first set of cards and a second subset of the second set of cards; a third subset of the first set of cards and a third subset of the second set of cards; a fourth subset of the first set of cards and a fourth subset of the second set of cards; and a fifth subset of the first set of cards and a fifth subset of the second set of cards, wherein the second subset, the third subset, the fourth subset, and the fifth subset of the first set of cards include three cards that are the same three cards included in the second subset, the third subset, the fourth subset, and the fifth subset of the second set of cards.

19. (canceled)

20. The method of claim 19, wherein two of three cards included in individual ones of the second, third, fourth, and fifth subsets of the first and second sets of cards are placed based on the game commands, and one of three cards included in individual ones of the second, third, fourth, and fifth subsets of the first and second sets of cards is discarded based on the game commands.

21. The method of claim 12, wherein the first card information and the second card information indicate the same subsets of the sets cards and wherein the card information includes card order information indicating an order in which the cards in the subsets of the sets of cards are presented on the client devices, the first card information including first card order information indicating the order in which the cards in the first subset of the first set of cards are presented on the first device, and the second card information including second card order information indicating the order in which the cards in the first subset of the second set of cards are presented on the second device, wherein the first card order information and the second card order indicate the same order.

22. The method of claim 12, further comprising:
receiving, at the computer system, wager information over the network from the client devices indicating an amount of consideration the first player or the second player wants to wager on the game or a subdivision of the game; and moving, by the computer system, consideration between player accounts based on the wager information and the scores of individual ones of the players determined for the game or the subdivision of the game.

23. A system for providing an electronic game, the system comprising:
physical computer processors configured by machine-readable instructions to:
determine sets of gameplay objects to be presented on client devices associated with players competing in an individual game against each other, the sets of gameplay objects including a first set of gameplay objects to be presented on a first client device associated with a first player and a second set of gameplay objects to be presented on a second client device associated with a second player, wherein the first set of gameplay objects and the second set of gameplay objects are the same such that the first player and the second player are competing against each other in the individual game with the sets of gameplay objects that are the same;
transmit gameplay object information indicating subsets of the sets of gameplay objects over a network to the client devices such that the subsets of the sets of gameplay objects are presented on the client devices, wherein first gameplay object information indicating a first subset of the first set of gameplay objects is transmitted to and presented on the first client device associated with the first player, and second gameplay object information indicating a first subset of the second set of gameplay objects is transmitted to and presented on the second client device associated with the second player;
receive game commands over the network from the client devices to place gameplay objects included in the subsets of the sets of gameplay objects into game spreads, the game spreads having a predetermined number of locations and individual locations having predetermined numbers of slots, wherein individual game spreads include groupings of gameplay objects defined by slots within the individual locations such that an individual grouping includes the gameplay objects placed in the slots within an individual location in an individual game spread;
execute the game commands received by placing the gameplay objects into the game spreads in indicated slots within indicated locations, the executed game commands including first commands from the first client device to place the gameplay objects included in the first subset of the first set of gameplay objects into the first game spread in first indicated slots within first indicated locations defined by the first commands, and second commands from the second client device to place the gameplay objects included in the first subset of the second set of gameplay objects into the second game spread in second indicated slots within second indicated locations defined by the second commands;
effectuate presentation, responsive to executing the first commands, of the first game spread on the second client device by transmitting first game spread information indicating the first game spread, including the gameplay objects placed within the first game spread, over the network such that the first game spread is visible to the second player;
effectuate presentation, responsive to executing the second commands, of the second game spread on the first client device by transmitting second game spread information indicating the second game spread, including the gameplay objects placed within the second game spread, over the network such that the second game spread is visible to the first player;
determine, responsive to the gameplay object information indicating a predetermined number of the subsets of the sets of gameplay objects being transmitted to the client devices and the game spreads being complete such that the gameplay objects have been placed in the predetermined numbers of slots within the predetermined number of locations, scores for individual ones of the players, wherein the scores are determined based on rankings of the game spreads compared to each other such that the first game spread including some gameplay objects from the first set of gameplay objects is directly compared to the second game spread including some gameplay objects from the second set of gameplay objects, and wherein the first game spread and the second game spread include at least one gameplay object that is the same.

24. A system for providing an electronic game, the system comprising:
physical computer processors configured by machine-readable instructions to:
determine a set of cards to be played for a round of an individual game;
distribute a first identical subset of the set of cards to each player of the individual game, wherein each player of the individual game plays against each of the other players with identical subsets of the set of cards;
receive commands from each player specifying how each player chooses to play the first subset of the set of cards;
distribute one or more additional subsets of the set of cards to each player, the additional subsets including a final subset of the set cards for the round of the game;
receive commands from each player specifying how each player chooses to play the additional subsets of the set of cards; and
score, responsive to receiving commands from each player specifying how each player chooses to play the final subset of the set of cards, each player's play for the round, wherein scoring each player's play includes directly comparing each individual player's play to each other individual player's play.

25. The system of claim 24, wherein the one or more physical computer processors are further configured by machine-readable instructions to determine, according to game rules, whether a first player's play of the cards for the round complies with a requirement for play for the round; and
determine, responsive to the first player's play of the cards for the round not complying with the requirement for play for the round, that the first player does not qualify to receive a score for the round, and/or that the first player receives a penalty.

26. The system of claim 24, wherein playing a subset of the set of cards includes indicating, for at least one card, a specified location on a game spread to place the card, or a discard of the card, in accordance with the game rules.

27. The system of claim 1, wherein the one or more physical computer processors are further configured by machine-readable instructions to:
facilitate multiple hands of the individual game including:
determining, responsive to a determination of scores for the individual ones of the players for the game spreads, second sets of cards, the second sets of cards including a first set of second cards to be presented on the first client device associated with the first player and a second set of second cards to be presented on the second client device associated with the second player, wherein the first set of second cards and the second set of second cards are the same, the second sets of cards being used within second game spreads by the individual players in a second hand;
determining, responsive to a determination of scores for the individual ones of the players for the second hand based on rankings of the second game spreads, third sets of cards, the third sets of cards including a first set of third cards to be presented on the first client device associated with the first player and a second set of third cards to be presented on the second client device associated with the second player, wherein the first set of third cards and the second set of third cards are the same, the third sets of cards being used within third game spreads by the individual players in a third hand; and
wherein the sets of cards, the second sets of cards, and the third sets of cards are determined by the one or more physical computer processors such that the second sets of cards and the third sets of cards are determined automatically responsive to the one or more physical processors receiving a command from the first client device and/or the second client device initiating another hand of the individual game.

28. The method of claim 12, further comprising:
facilitating multiple hands of the individual game including:
determining, responsive to a determination of scores for the individual ones of the players for the game spreads, second sets of cards, the second sets of cards including a first set of second cards to be presented on the first client device associated with the first player and a second set of second cards to be presented on the second client device associated with the second player, wherein the first set of second cards and the second set of second cards are the same, the second sets of cards being used within second game spreads by the individual players in a second hand;
determining, responsive to a determination of scores for the individual ones of the players for the second hand based on rankings of the second game spreads, third sets of cards, the third sets of cards including a first set of third cards to be presented on the first client device associated with the first player and a second set of third cards to be presented on the second client device associated with the second player, wherein the first set of third cards and the second set of third cards are the same, the third sets of cards being used within third game spreads by the individual players in a third hand; and
wherein the sets of cards, the second sets of cards, and the third sets of cards are determined by the one or more physical computer processors such that the second sets of cards and the third sets of cards are determined automatically responsive to the one or more physical processors receiving a command from the first client device and/or the second client device initiating another hand of the individual game.

29. The system of claim 1, wherein the players compete in the individual game asynchronously such that the first player is able to complete the first game spread without waiting for the second player by placing the cards in the predetermined numbers of slots within the predetermined number of locations via the game commands such that the first user is able to place 13 of 17 cards presented in the subsets of the sets of cards in the first game spread without waiting for the second player to place one or more of the cards in the second set of cards.

30. The method of claim 12, wherein the players compete in the individual game asynchronously such that the first player is able to complete the first game spread without waiting for the second player by placing the cards in the predetermined numbers of slots within the predetermined number of locations via the game commands such that the first user is able to place 13 of 17 cards presented in the subsets of the sets of cards in the first game spread without waiting for the second player to place one or more of the cards in the second set of cards.

31. The system of claim 1, wherein the first game spread and the second game spread have at least five cards that are identical.

32. The method of claim 12, wherein the first game spread and the second game spread have at least five cards that are identical.
